(19) United States
(12) Patent Application Publication
(10) Pub. No.: US 2018/0247497 A1
(43) Pub. Date: Aug. 30, 2018

(54) DEVICE TO MODIFY PERSONAL RESPONSE

(71) Applicant: HARVEY NUNNERY, LAPLACE, LA (US)

(72) Inventor: HARVEY NUNNERY, LAPLACE, LA (US)

(21) Appl. No.: 15/892,547

(22) Filed: Feb. 9, 2018

Related U.S. Application Data
(60) Provisional application No. 62/463,796, filed on Feb. 27, 2017.

(51) Int. Cl. G08B 7/06

(52) U.S. Cl. CPC G08B 7/06

(57) ABSTRACT

A device to suggest a modification of personal response by a user to potentially violent situations comprising a digital device with a display face showing an image of persons having a familial relationship to the user with a digital device display face showing an image of persons having a familial relationship to the user, a prerecorded audio or video message from one or more persons having a familial relationship to the user and a a push-start button for the user to activate the message.

This application claims priority from U.S. Provisional Application No. 62/463,796 (the '796 application), filed Feb. 27, 2017. The '796 application is incorporated herein by reference.

### BACKGROUND OF THE INVENTION

With the ever expanding population of road vehicles and resulting traffic congestion, accidents and vehicular interaction, there has arisen a phenomenon typically called “road rage.” With the widespread use of wireless devices equipped with cameras, incidents of “road rage” are routinely recorded and disseminated on the internet and social media. Unfortunately, road rage incidents can escalate into violent confrontations between drivers, occasionally resulting in the death of one or more of the participants—particularly where firearms are involved. In these terrible incidents, the resulting impact of death and injury, criminal prosecution, devastation of family and possible imprisonment always exceeds the importance of any encounter or perceived insult that gave rise to the incident. Likewise, the same can be said about incidents of domestic violence that can lead to tragic results. Something is needed to defuse these confrontations BEFORE they escalate into violence with irreversible consequences.

### SUMMARY OF THE INVENTION

The present invention is designed to help a person think before they act when involved in a situation of road rage or potential domestic violence. The present invention will remind the person involved of those things that are most important and most likely to be lost by acting violently. For most people those most important things are family, spouse, children, and loved ones. What the present invention provides is an instant visual presentation of an image of loved ones and a sound recording in the voice and words of a loved one such as a child or spouse. The present invention is currently configured as a digital wrist watch with a digital time display, a screen with a picture of the loved ones of the user, a push-start button to play a recording of a loved ones voice with a simple reminder of what was at stake if the user acted violently in an impending situation.

It is an object of this invention to provide a device intended to suggest a modification of personal response by a user to potentially violent situations comprising a digital device with a display face showing an image of persons having a familial relationship to the user, an audio or video message prerecorded by one or more persons having a familial relationship where said message suggests a modification of personal response by a user to a potentially violent situation, and a push-start button for the user to activate said audio or video message. It is intended that the term familial relationship shall include but not be limited to immediate family members such as children, spouses, and parents as well as life partners, and close friends of the user.

### BRIEF DESCRIPTION OF THE DRAWING

FIG. 1 shows a perspective view of the inventive device in a wrist watch embodiment.

### DETAILED DESCRIPTION OF THE INVENTION

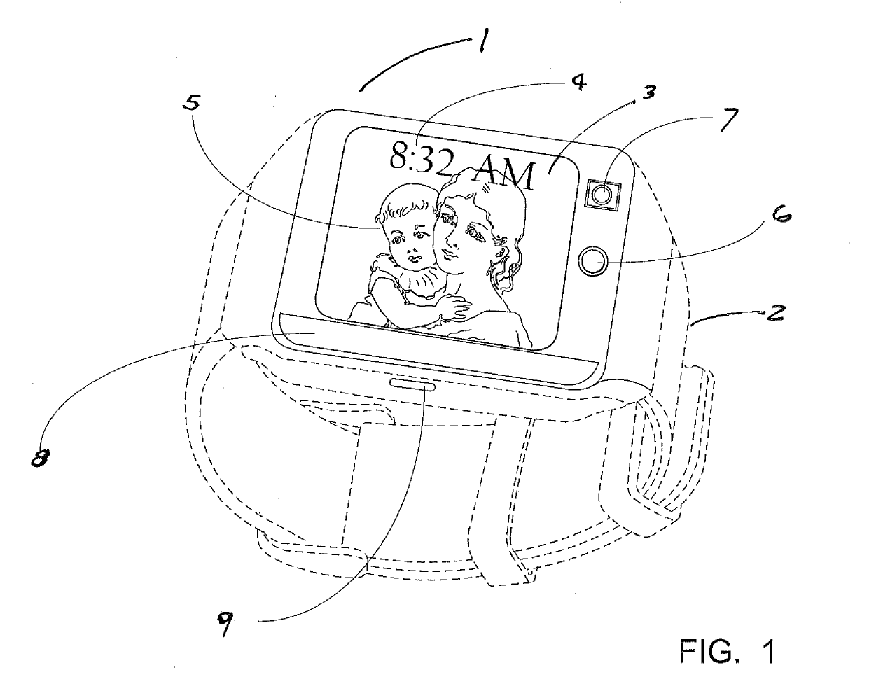

As presented in FIG. 1, the inventive device is depicted in a digital wrist watch configuration, but alternative embodiments such as smart phones or other personal digital devices are intended as long as the device is readily available for action by the user, if the user decides to use it.

The embodiment in FIG. 1 shows the device 1 mounted on a wrist strap 2, just as any watch, and the device 1 may include all the features of any digital watch such as a charging inlet 9. As shown the inventive device 1 has a display face 3 showing the time 4 and also a picture 5 of the user's loved ones such as a wife and child. Also depicted is a push-start button 6 to play a prerecorded message from a speaker 8 in the voice and words of a loved one such as a child or spouse to remind the user of what might be lost by rage driven action. Likewise, the device 1 could play a video recording of a loved one such as a child or spouse with a similar message. If the user so chooses, when facing a road rage situation or other potentially violent situation that could quickly escalate with terrible consequences, the user can simply press the push-start button 6 and see the picture of loved ones and hear a recording of a loved one imploring prudent action. Likewise, depending on the device, the push-start button 6 could be pressed to start a video of loved ones imploring prudent action. The invention 1 is intended to “de-escalate” the situation.

I claim:

1. A device intended to suggest a modification of personal response by a user to potentially violent situations comprising a digital device with a display face showing an image of persons having a familial relationship to the user, an audio message prerecorded by one or more persons having a familial relationship where said message suggests a modification of personal response by a user to a potentially violent situation, and a push-start button for the user to activate said audio message.

2. The device of claim 1 where the device is a digital watch.

3. The device of claim 1 where the device is a smart phone.

4. A device intended to suggest a modification of personal response by a user to potentially violent situations comprising a digital device with a video message prerecorded by one or more persons having a familial relationship where said message suggests a modification of personal response by a user to a potentially violent situation, and a push-start button for the user to activate said video message.

5. The device of claim 4 where the device is a digital watch.

6. The device of claim 1 where the device is a smart phone.
